(19) United States
(12) Patent Application Publication
(10) Pub. No.: US 2016/0016274 A1
(43) Pub. Date: Jan. 21, 2016

(54) MEASUREMENT DEVICE FOR MACHINING CENTER

(71) Applicant: FARO Technologies, Inc., Lake Mary, FL (US)

(72) Inventor: Markus Grau, Korntal-Muenchingen (DE)

(21) Appl. No.: 14/728,014

(22) Filed: Jun. 2, 2015

Related U.S. Application Data
(60) Provisional application No. 62/025,205, filed on Jul. 16, 2014.

(51) Int. Cl. B23Q 17/24; G01B 11/25

(52) U.S. Cl. CPC B23Q 17/2471; G01B 11/25

(57) ABSTRACT

A computer numerical control (CNC) machining center is provided. The CNC machining center includes a spindle configured to receive a cutting tool having a tool mount. A tool magazine is provided having a plurality of holders, each holder configured to receive a tool having the tool mount. A primary induction power supply operably coupled to the spindle. A non-contact three-dimensional (3D) measurement device having the tool mount is provided. The 3D measurement device is movable between one of the tool magazine holders and the spindle. The 3D measurement device having a secondary induction power supply configured to generate electrical power to operate the 3D measurement device when the 3D measurement device is coupled to the spindle.

### CROSS-REFERENCE TO RELATED APPLICATIONS

The present Application is a nonprovisional application claiming benefit of U.S. Provisional Application Ser. No. 62/025205 filed on Jul. 16, 2014 entitled Measurement Device for Machining Center, the contents of which are incorporated by reference in their entirety.

### BACKGROUND OF THE INVENTION

The subject matter disclosed herein relates to a machining center and in particular to a machining center having an integrated noncontact measurement device.

A computer controlled machining center, such as a computational numerical control (CNC) machining center is used to produce complex components. The CNC machining centers can perform 5 and 6 axis operations at very high speeds. These systems typically have an automatic tool changing system that allows the machining center to retrieve a specific tool for each operation without stoppage or intervention from the operator.

While CNC machining centers have improved the ability to accurately machine components, the produced parts still need to be inspected to ensure the components are fabricated according to specification. Historically, the components or a sample group of components were transported to an inspection room where highly skilled inspection operators used measurement devices to determine the dimensions of the component. As metrology devices have improved and new devices such as articulated arm coordinate measurement devices developed, the location of the inspection has moved from the specialized inspection room to areas adjacent the machining center.

While moving the location of the inspection adjacent the machining center has reduced the time and lowered costs, the inspection process still typically requires the machining center to stop operations while the operator performs the inspection. Commonly, the work piece is removed from the machining center when the inspection is performed. Thus the inspection still slows the time to produce components and utilizes additional operator time.

Accordingly, while existing CNC machining centers are suitable for their intended purpose the need for improvement remains, particularly in providing a CNC machining center which reduces the time and cost to perform inspections of a work piece.

### BRIEF DESCRIPTION OF THE INVENTION

According to one aspect of the invention, a computer numerical control (CNC) machining center is provided. The CNC machining center including a spindle configured to receive a cutting tool having a tool mount. A tool magazine is provided that includes a plurality of holders, each holder configured to receive a tool having the tool mount. A primary induction power supply is operably coupled to the spindle. A non-contact three-dimensional (3D) measurement device is provided having the tool mount. The 3D measurement device being movable between one of the tool magazine holders and the spindle, the 3D measurement device having a secondary induction power supply configured to generate electrical power to operate the 3D measurement device when the 3D measurement device is coupled to the spindle.

According to another aspect of the invention, a method of machining a work piece in a CNC machining center is provided. The method comprising: coupling a tool to a spindle; engaging the tool to the work piece to form a feature; moving the tool from the spindle to a tool magazine; moving a non-contact 3D-measurement device from the tool magazine to the spindle; energizing a primary induction power supply; electrically powering the 3D measurement device with the primary induction power supply when it is coupled to the spindle; moving the spindle over the feature with the 3D-measurement device energized; and acquiring 3D coordinates of points on the feature with the 3D-measurement device as the spindle is moved over the feature.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a machining center in accordance with an embodiment of the invention;

FIG. 2 is a side view of the machining center of FIG. 1 with a measurement device coupled to the machine head;

FIG. 3 is an enlarged side view of the machine head with the measurement device;

FIG. 4 is a schematic diagram of the measuring device of FIG. 2;

FIG. 5 is a schematic illustration of a laser line probe measuring device;

FIG. 6 is a schematic illustration of a structured light scanner;

FIG. 7 is another schematic illustration of the structured light scanner of FIG. 6; and

FIG. 8 is a flow diagram of a method of measuring a work piece within a machining center.

The detailed description explains embodiments of the invention, together with advantages and features, by way of example with reference to the drawings.

### DETAILED DESCRIPTION OF THE INVENTION

Embodiments of the present invention provide advantages in allowing for the inspection of work pieces being machined within a CNC machining center without having to remove the work piece. Embodiments of the present invention provide advantages in allowing the inspection of the work piece in an automated manner without interruption by the machine operator. Still further embodiments of the invention provide a noncontact measurement device that may be stored and removed from the machining center tool magazine during operation. Still further embodiments of the invention provide advantages in eliminating cables or mechanical connections between the noncontact measurement device and an external computing device.

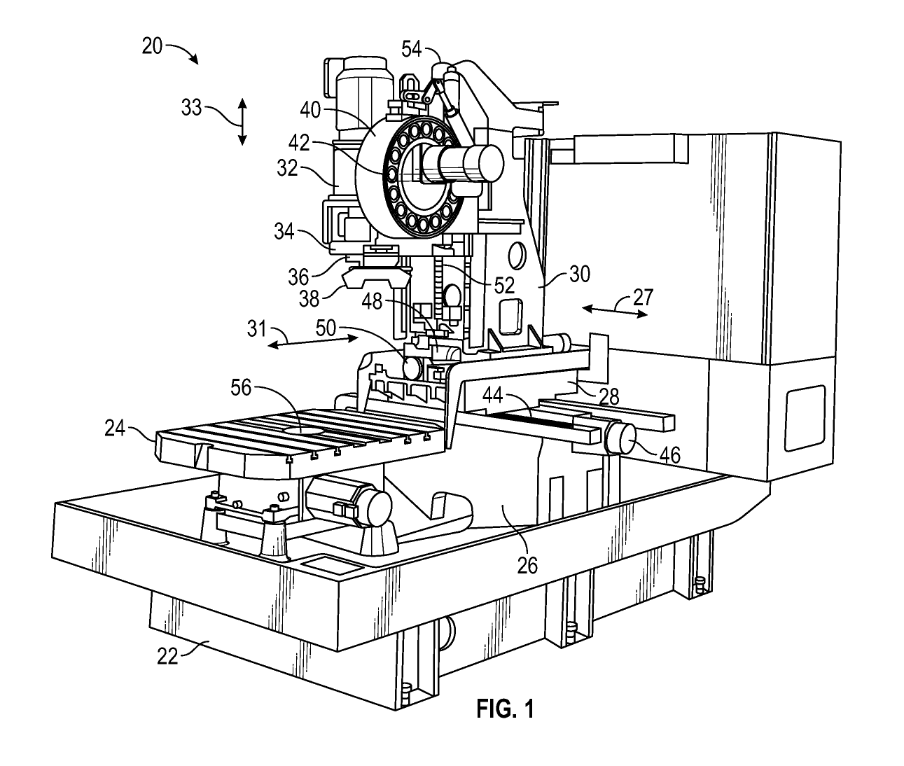

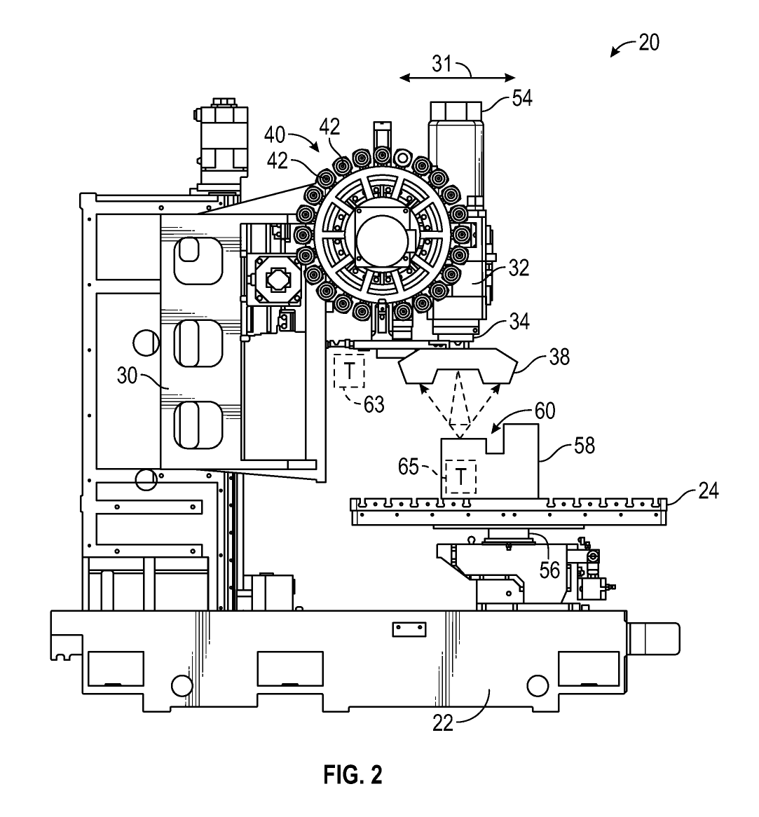

Referring now to FIGS. 1 and 2, a CNC machining center 20 is shown in accordance with an embodiment of the invention. The machining center 20 includes a base 22 with a rotatable work table 24 located on one end of the base 22. A sliding rail unit 26 is disposed on an opposite end of the base 22. A sliding seat 28 is movably mounted to the sliding rail unit 26 to move in a first horizontal direction 27. A post 30 is mounted to the sliding seat 28 and is movable in a second horizontal direction 31 that is substantially perpendicular to the first horizontal direction. It should be appreciated that the first and second horizontal directions define the X and Y axis of movement for the machining center 20. The post 30 extends in a direction substantially perpendicular to the plane defined by the first and second horizontal directions.

A spindle seat 32 is movably mounted to the post 30 and movable in a direction 33 substantially perpendicular to the plane formed by the first and second horizontal directions to define the Z-axis of the machining center. A spindle 34 with a tool mount 36 is coupled to the spindle seat 32. As will be discussed in more detail herein, the tool mount 36 is configured to receive a tool (not shown) or a noncontact measurement device 38 during operation. In the exemplary embodiment, the machining center 20 includes a tool magazine 40 arranged to receive and store tools and noncontact measurement device 38. The tool magazine 40 includes a plurality of holders 42 that are similarly configured to receive the shank of a tool or noncontact measurement device 38. The tools and noncontact measurement device 38 may be transferred between the tool magazine 40 and the tool mount 36 automatically during operation as is known in the art, such as with a tool changing arm for example.

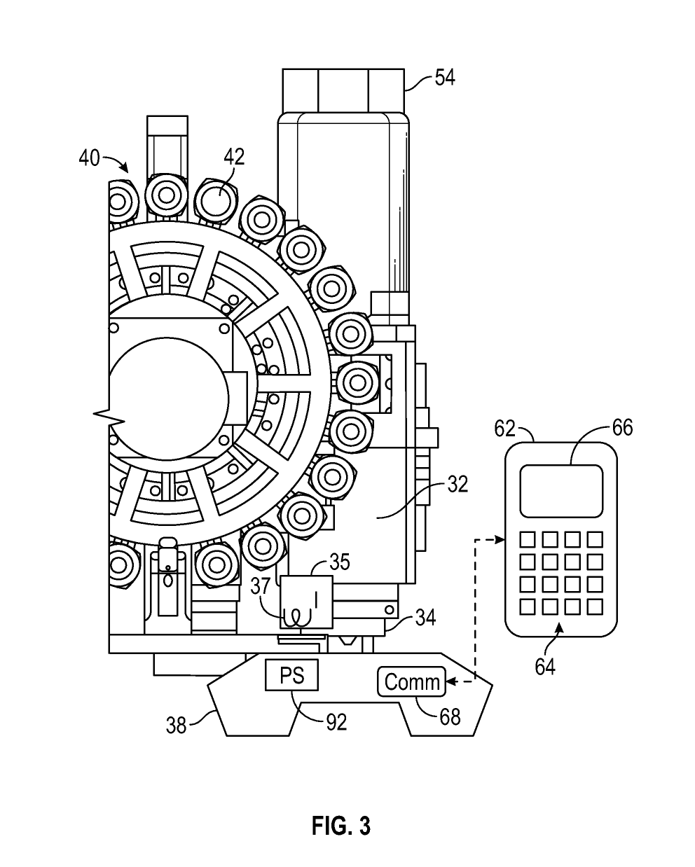

In the exemplary embodiment, an induction power supply 35 (FIG. 3) is mounted either on or adjacent to the spindle 34. As will be discussed in more detail below, the induction power supply 35 includes a primary circuit 37 that allows for providing of electrical power wirelessly to a device mounted in the tool mount 36, such as 3D measurement device 38, for example, without the use of a cable or other physical conductor to transfer power.

It should be appreciated what while the tool magazine 40 is illustrated with the holders 42 extending perpendicular to the Z-axis about the circumference of the tool magazine 40, this is for exemplary purposes and other tool magazine and holder configurations are possible. For example, the tool magazine may have holders that extend radially from the outer diameter/periphery of the tool magazine. In another embodiment, the holders may be oriented in a direction parallel to the Z-axis. In another embodiment, the tool magazine may include a conveyor type system that follows a serpentine path. Further, while the tool magazine 40 is illustrated as being mounted directly adjacent the spindle 34, in other embodiments, the tool magazine may be remotely mounted from the spindle. Further, the tool magazine may be remotely located in an enclosure that may be selectively isolated (e.g. with a movable door) to shield the tool magazine and the tools stored therein from debris, cooling fluid and lubricants used during the machining process.

The sliding seat 28 is driven along first horizontal direction 27 by a threaded rod 44 that is rotated by a servo motor 46. Similarly, the post 30 is driven in the second horizontal direction 31 by a threaded rod 48, which is rotated by a servo motor 50. The spindle seat 32 is moved along the Z-axis 33 by a threaded rod 52, which is rotated by a servo motor 54. It should be appreciated that while embodiments herein describe a threaded rod and servo motor arrangement, this is for exemplary purposes and the claimed invention should not be so limited. In other embodiments, other devices such as hydraulic or linear actuators may be used. Further, in some embodiments, the work table 24 may be mounted to rails and movable in multiple directions relative to the spindle seat 32. The work table 24 may also be mounted to a vertical shaft 56 that allows rotation of the work table 24 relative to the base 22.

The machining center 20 may further include a controller 62 (FIG. 3). The controller 62 may be described in the general context of computer system-executable instructions, such as program modules that may include routines, programs, objects, components, logic, data structures and so on that perform particular tasks or implement particular abstract data types. The controller 62 may be a local client of a distributed cloud computing environment where some tasks are performed by remote processing devices that are linked through a communications network. In a distributed computing environment, program modules may be located in both local and remote computer system storage media including memory storage devices.

The controller 62 may be in the form of a general-purpose computing device, also referred to as a processing device. The components of the controller may include, but are not limited to, one or more processors or processing units, a system memory, and a bus that couples the various system components including system memory to the processor. System memory can include computer system readable media in the form of volatile memory, such as random access memory (RAM and/or cache memory. The controller 62 may further include removable/non-removable volatile/non-volatile storage media, such as but not limited to magnetic media or optical media for example.

A program/utility, having a set of program modules, may be stored in memory by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions or methodologies of embodiments of the invention described herein.

The controller 62 may also communicate with one or more devices, such as a keyboard 64, a pointing device, a display 66, etc.; one or more devices that enable a user to interact with controller 62; or any devices (e.g. a communications circuit, network card, etc.). Such communication may occur via Input/Output (I/O) interfaces. Controller 62 may further communicate via one or more networks, such as a local area network (LAN), a general wide-area network (WAN), or a public network (e.g. the Internet) via a communications circuit. The communications may be via a wired communications medium (e.g. Ethernet, USB, etc.) or a wireless communications medium. The wireless communications medium may include IEEE 802.11 (WiFi), a Bluetooth® (IEEE 802.15.1 and its successors), RFID, near field communications (NFC), or cellular (including LTE, GSM, EDGE, UMTS, HSPA and 3GPP cellular network technologies) for example. It should be appreciated that the controller 62 is further configured to communicate with a communications circuit 68 in 3D measurement device 38.

In one embodiment, the machining center 20 may further include a first temperature sensor 63 and a second temperature sensor 65 (FIG. 3). The first temperature sensor 63 is disposed within an internal of the machining center to measure and provide an indication of the temperature of different zones within the machining center 20. The first temperature sensor 63 may also be coupled to, located within, or external to the 3D measurement device 38. The first temperature sensor 63 may be a thermocouple, a thermistor, a resistance thermometer or a silicon bandgap sensor for example. In one embodiment, the first temperature sensor 63 is a pyrometer that optically measures the temperature of a surface, such as the surface of the work table 24 for example. The second temperature sensor 65 measures the temperature of the work piece 58. Typically, the second temperature sensor 65 will be mounted directly on the work piece 58. Similarly, the second temperature sensor 65 may be a thermistor, a resistance thermometer or a silicon bandgap sensor for example. In one embodiment, the second temperature sensor 65 is a pyrometer that optically measures the temperature of the surface of the work piece 58. It should be appreciated that the pyrometer may be separately mounted distal from the work piece 58. In one embodiment, the temperature sensors 63, 65 are combined into a single temperature sensor configured to measure both the temperature of the work piece and different zones within the machining center enclosure. The temperature sensors 63, 65 cooperate with the controller 62 to acquire temperature data regarding the work piece 58 and environment to allow for the compensation of measurements due to the thermal coefficient of expansion of the work piece material. Typically, the dimensional measurements are compensated to provide

It should be appreciated that while embodiments herein describe a three-axis machining center, this is for exemplary purposes and the claimed invention should not be so limited. In other embodiments, the machining center 20 may have more or fewer axes. Further, the machining center may be a vertical machining center, a horizontal machining center, a CNC milling machine, a CNC lathe, a CNC grinding machine or a CNC gear cutting machine for example.

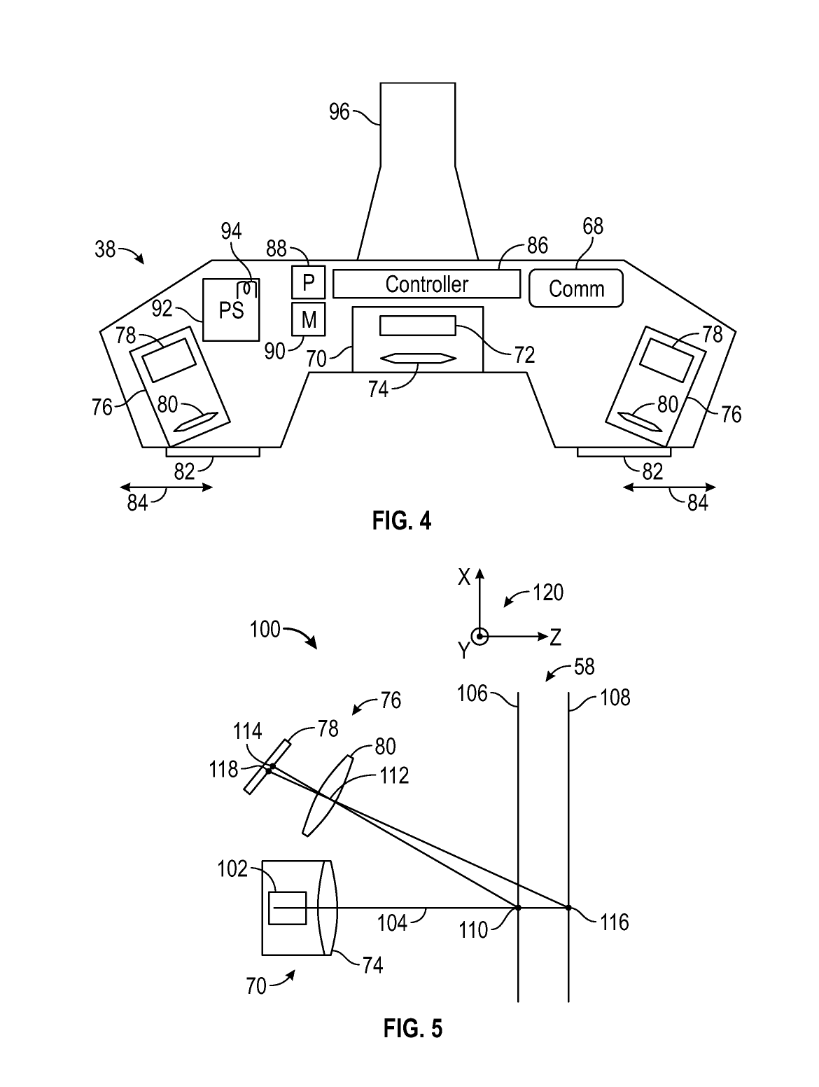

Referring now to FIG. 4, an embodiment is shown of 3D measurement device 38. In the exemplary embodiment, the 3D measurement device 38 is an optical measurement device that uses light, such as a laser (coherent light) or structured light for example. The 3D measurement device 38 includes a projector 70 having a light source 72 and a lens system 74. Arranged in a fixed geometric relationship with the projector 70 is at least one camera 76 arranged to receive light emitted from the projector 70 and reflected off of the work piece 58. Each camera 76 includes a photosensitive array 78 and a lens 80. In some embodiments, a shutter 82 is disposed over each lens system 80 to prevent fluids and debris from the machining operation from contacting the lens system 80 while the 3D measurement device 38 is stored in the tool magazine 40. The shutter 82 moves in the direction indicated by the arrow 84 between an open and closed position. In one embodiment, the shutter 82 is in the closed position when the 3D measurement device 38 is in the tool magazine 40 and in the open position when the 3D measurement device 38 in mounted to the spindle and energized.

The 3D measurement device 38 also includes a controller 86 that may be a digital circuit, the controller having a microprocessor 88 that includes memory 90, for example, or an analog circuit. The controller 86 is electrically coupled to the projector 70 and cameras 76 to provide operational control during operation. In one embodiment, the controller 86 is in asynchronous bidirectional communication with the controller 62 (FIG. 3). The communication connection between the controller 86 and the controller 62 may be via a direct or indirect wireless connection (e.g. Bluetooth or IEEE 802.11). A power supply 92 provides electrical power to the controller 86, the projector 70 and cameras 76. In the exemplary embodiment, the power supply 92 is an induction power supply having a secondary coil circuit 94 that is configured to generate electrical power for the 3D measurement device 38 in response to a magnetic field generated by the primary coil 37. The coupling of the power supplies 35, 92 allows for the operation of the 3D measurement device 38 while mounted in the spindle 34 without requiring the operator to physically connect cables to the 3D measurement device 38.

The 3D measurement device 38 further includes a tool mount 96. The tool mount 96 is sized and shaped to be received in both the holders 42 of tool magazine 40 and the spindle 34. The tool mount 96 may further have one or more features that allow the machining center to transfer in an automated manner the 3D measurement device 38 between the tool magazine 40 and the spindle 34.

In the exemplary embodiment, the 3D measurement device 38 is a laser line probe (LLP) or line scanner. The principle of operation of a line scanner is shown schematically in FIG. 5. A top view of a line scanner 100 includes a projector 70 and a camera 76, the camera including a lens system 80 and a photosensitive array 78 and the projector including an objective lens system 74 and a pattern generator 102. The pattern generator 102 may include a low-coherence light source 72 (FIG. 4) and a beam delivery system. The projector 70 projects a line 104 (shown in the figure as projecting out of the plane of the paper) onto the surface of work piece 58, which may be placed at a first position 106 or a second position 108. Light scattered from the work piece at the first point 110 travels through a perspective center 112 of the lens system 80 to arrive at the photosensitive array 78 at position 114. Light scattered from the work piece at the second position 116 travels through the perspective center 112 to arrive at position 118. By knowing the relative positions and orientations of the projector 70, the camera lens system 80, the photosensitive array 78, and the position 114 on the photosensitive array, it is possible to calculate the three-dimensional coordinates of the point 110 on the work piece surface. Similarly, knowledge of the relative position of the point 118 rather than point 114 will yield the three-dimensional coordinates of the point 116. The photosensitive array 78 may be tilted at an angle to satisfy the Scheimpflug principle, thereby helping to keep the line of light on the work piece surface in focus on the array.

One of the calculations described herein above yields information about the distance of the object from the line scanner—in other words, the distance in the z direction, as indicated by the coordinate system 120. The information about the x position and y position of each point 110 or 116 relative to the line scanner is obtained by the other dimension of the photosensitive array 78, in other words, the y dimension of the photosensitive array. Since the plane that defines the line of light as it propagates from the projector 70 to the object is known from the coordinate measuring capability of the machining center 20 to track the position of the spindle, it follows that the x position of the point 110 or 116 on the work piece surface is also known. Hence all three coordinates—x, y, and z—of a point on the object surface can be found from the pattern of light on the two-dimensional photosensitive array 78.

It should be appreciated that the LLP 100 may include a second camera 76 arranged on a side of the projector 70 opposite the other camera 76. Both cameras 76 view the same projected light but from different angles. This provides advantages in allowing an area not visible to the camera on one side of the projector to be imaged by the camera on the opposite side, and vice versa.

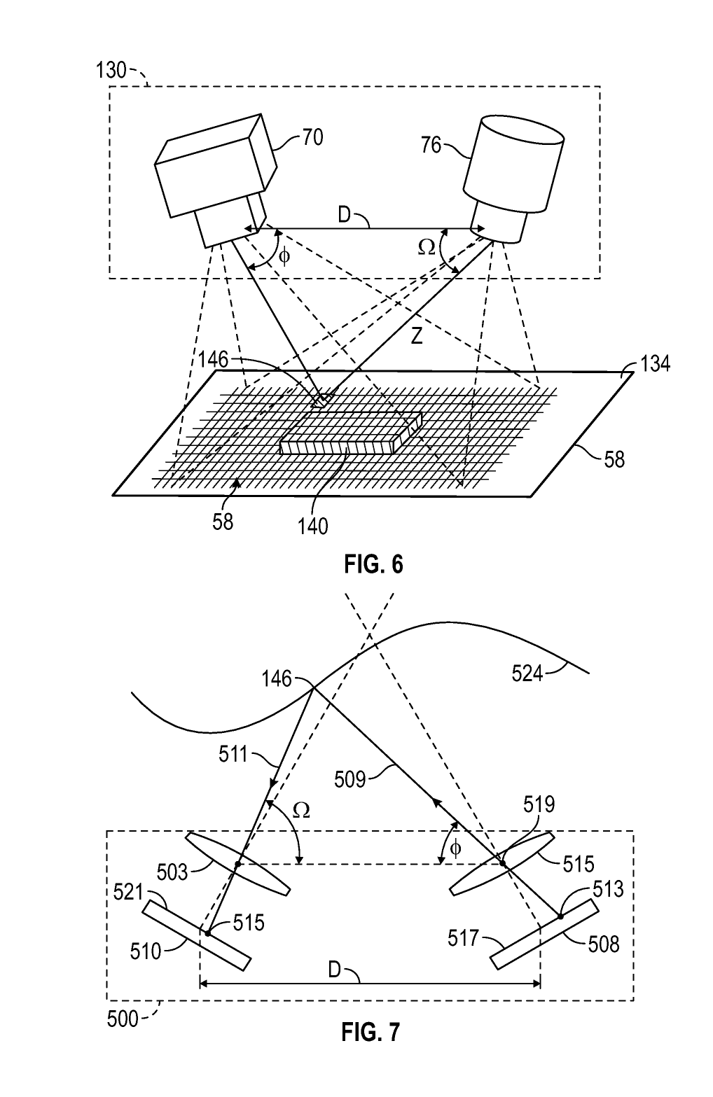

In another embodiment, the 3D measurement device 38 is an image scanning device that uses structured light. Referring now to FIGS. 6 and 7, the operation of a structured light device 130 will be described. The device 130 first emits a structured light pattern 132 with projector 70 onto surface 134 of the work piece 58. The structured light pattern 132 may include the patterns such as those disclosed in the journal article “DLP-Based Structured Light 3D Imaging Technologies and Applications” by Jason Geng published in the Proceedings of SPIE, Vol. 7932, which is incorporated herein by reference. The light 136 from projector 70 is reflected from the surface 134 and the reflected light 138 is received by the camera 76. It should be appreciated that variations or features in the surface 134, such as protrusion 140 for example, create distortions in the structured pattern when the image of the pattern is captured by the camera 76. Since the pattern is formed by structured light, it is possible in some instances for the controller 86 or controller 62 to determine a one to one correspondence between the pixels in the emitted pattern, such as pixel 142 for example, and the pixels in the imaged pattern, such as pixel 144 for example. This enables triangulation principals to be used to determine the coordinates of each pixel in the imaged pattern. The collection of three-dimensional coordinates of the surface 134 is sometimes referred to as a point cloud. By moving the device 130 over the surface 134, such as with the spindle 34 for example, a point cloud may be created of the entire work piece 58.

To determine the coordinates of the pixel, the angle of each projected ray of light 136 intersecting the work piece 58 in a point 146 is known to correspond to a projection angle phi (φ), so that φ information is encoded into the emitted pattern. In an embodiment, the system is configured to enable the φ value corresponding to each pixel in the imaged pattern to be ascertained. Further, an angle omega (Ω) for each pixel in the camera is known, as is the baseline distance “D” between the projector 70 and the camera 76. Therefore, the distance “Z” from the camera 76 to the location that the pixel has imaged using the equation:

$$\frac{Z}{D} = \frac{sin ( Φ )}{sin ( Ω + Φ )} \qquad ( 1 )$$

Thus three-dimensional coordinates may be calculated for each pixel in the acquired image.

In general, there are two categories of structured light, namely coded and uncoded structured light. A common form of uncoded structured light relies on a striped pattern varying in a periodic manner along one dimension. These types of patterns are usually applied in a sequence to provide an approximate distance to the object. Some uncoded pattern embodiments, such as the sinusoidal patterns for example, may provide relatively highly accurate measurements. However, for these types of patterns to be effective, it is usually necessary for the scanner device and the object to be held stationary relative to each other. Where the scanner device or the object are in motion (relative to the other), then a coded pattern may be used. A coded pattern allows the image to be analyzed using a single acquired image. Some coded patterns may be placed in a particular orientation on the projector pattern (for example, perpendicular to epipolar lines on the projector plane), thereby simplifying analysis of the three-dimensional surface coordinates based on a single image.

Epipolar lines are mathematical lines formed by the intersection of epipolar planes and the source plane 148 or the image plane 150 (the plane of the camera sensor) in FIG. 7. An epipolar plane may be any plane that passes through the projector perspective center and the camera perspective center. The epipolar lines on the source plane 148 and the image plane 150 may be parallel in some cases, but in general are not parallel. An aspect of epipolar lines is that a given epipolar line on the projector plane 148 has a corresponding epipolar line on the image plane 150. Therefore, any particular pattern known on an epipolar line in the projector plane 148 may be immediately observed and evaluated in the image plane 150. For example, if a coded pattern is placed along an epipolar line in the projector plane 148, the spacing between the coded elements in the image plane 144 may be determined using the values read out of the pixels of the camera sensor 78 (photosensitive array). This information may be used to determine the three-dimensional coordinates of a point 146 on the work piece 58. It is further possible to tilt coded patterns at a known angle with respect to an epipolar line and efficiently extract object surface coordinates.

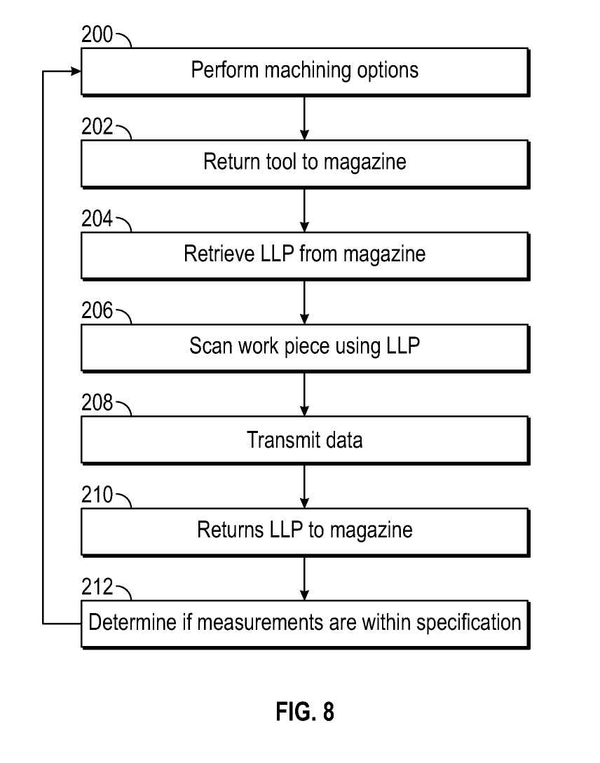

Referring now to FIGS. 1, 2 and 8, the operation of the machining center 20 will be described. In the exemplary embodiment, a work piece 58 is clamped to the work table 24 as is known in the art. The work piece 58 may include one or more features 60 that are formed in the work piece 58 by a tool (not shown) in step 200. The tools are mounted to the spindle 34 of the machining center 20 to form the features 60. Once the features 60 are formed, it is desirable to measure the features 60 to ensure they are within the desired specifications. In the exemplary embodiment, the tool magazine 40 includes at least one noncontact 3D measurement device 38. The 3D measurement device 38 may be a laser line probe, a structured light scanner, or a combination thereof for example. To measure the features 60, the machining center 20 returns the tool used to form the features 60 to the tool magazine 40 in step 202 and retrieves the 3D measurement device 38 from storage in step 204. As discussed above the holders 42 are configured to release the 3D measurement device 38 to allow the device to be transferred from storage in the tool magazine 40 to the spindle 34.

With the 3D measurement device 38 mounted in the spindle 34, the spindle seat 32 is moved, such as by actuation of the servo motors 46, 50, 54 in the directions 27, 31, 33. The 3D measurement device 38 may then be moved adjacent the features 60 and the desired measurements acquired in step 206. These acquired measurements may be then by transmitted to the controller 62 via the wireless communications medium in step 208. The 3D measurement device is returned to the tool magazine in step 210. The acquired measurements may be compared with predetermined values and determine if the formed features 60 are within a predetermined specification in step 212. As discussed above, one or more temperature sensors may be used to compensate the measurements to account for dimensional changes based on the thermal coefficient of expansion. Thus, the machining center 20 is able to automatically form a feature 60 and perform an inspection of the dimensions without intervention from the operator. It should be appreciated that if the dimensions are out of specification, the machining center 20 may alert the operator, or automatically take other corrective action (e.g. perform further machining operation).

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A computer numerical control (CNC) machining center comprising:
a spindle configured to receive a cutting tool having a tool mount;
a tool magazine having a plurality of holders, each holder configured to receive a tool having the tool mount;
a primary induction power supply operably coupled to the spindle; and
a non-contact three-dimensional (3D) measurement device having the tool mount, the 3D measurement device being movable between one of the plurality of holders and the spindle, the 3D measurement device having a secondary induction power supply configured to generate electrical power to operate the 3D measurement device when the 3D measurement device is coupled to the spindle.

2. The CNC machining center of claim 1 wherein the 3D measurement device includes a wireless communication circuit configured to transmit measurement data from the 3D measurement device to a remote device.

3. The CNC machining center of claim 2 wherein the 3D measurement device is a laser line probe.

4. The CNC machining center of claim 3 wherein the 3D measurement device comprises:
a projector that includes a light source, a first lens system, the light source configured to emit light, the first lens system configured to receive the light and to spread out the light into a first line of light;
a first camera that includes a second lens system and a first photosensitive array, the first camera having predetermined characteristics including a focal length of the second lens system and a position of the first photosensitive array relative to the second lens system to define a geometrical configuration, and wherein the second lens system is configured to collect the light reflected by or scattered off a work piece as a first collected light and image the first collected light onto the first photosensitive array, the first photosensitive array configured to convert the first collected light into a first electrical signal; and
an electronic circuit including a processor, wherein the electronic circuit is configured to determine 3D coordinates of a plurality of points of light projected on the work piece by the projector, the 3D coordinates based at least in part on the first electrical signal, the first camera predetermined characteristics, and the geometrical configuration.

5. The CNC machining center of claim 4 wherein the 3D measurement device further comprises a second camera disposed opposite the first camera from the projector, the second camera includes a third lens system and a second photosensitive array, the second camera having predetermined characteristics including a focal length of the third lens system and a position of the second photosensitive array relative to the third lens system, and wherein the third lens system is configured to collect the light reflected by or scattered off the work piece as a second collected light and second image the second collected light onto the second photosensitive array, the second photosensitive array configured to convert the second collected light into a second electrical signal.

6. The CNC machining center of claim 5 wherein the electronic circuit is further configured to determine the 3D coordinates of the plurality of points of light projected on the work piece by the projector, the 3D coordinates based at least in part on the first electrical signal, the second electrical signal, the first camera predetermined characteristics, the second camera predetermined characteristics and the geometrical configuration.

7. The CNC machining center of claim 4 wherein the 3D measurement device further includes a movable shutter disposed adjacent the second lens system, the movable shutter movable from a first position when the 3D measurement device is in the tool magazine to a second position when the 3D measurement device is coupled to the spindle.

8. The CNC machining center of claim 4 further comprising:
a first temperature sensor configured to measure a first temperature indicative of a temperature of the work piece; and
wherein the electronic circuit is further configured to determine 3D coordinates of the plurality of points of light projected on the work piece by the projector, the 3D coordinates based at least in part on the first electrical signal, the first camera predetermined characteristics, the geometrical configuration, and the first temperature.

9. The CNC machining center of claim 4 further comprising:
a second temperature sensor configured to measure a second temperature indicative of a temperature of at least one zone within the machining center; and
wherein the electronic circuit is further configured to determine 3D coordinates of the plurality of points of light projected on the work piece by the projector, the 3D coordinates based at least in part on the first electrical signal, the first camera predetermined characteristics, the geometrical configuration, and the second temperature.

10. A method of machining a work piece in a CNC machining center, the method comprising:
coupling a tool to a spindle;
engaging the tool to the work piece to form a feature;
moving the tool from the spindle to a tool magazine;
moving a non-contact 3D-measurement device from the tool magazine to the spindle;
energizing a primary induction power supply;
electrically powering the 3D measurement device with the primary induction power supply when it is coupled to the spindle;
moving the spindle over the feature with the 3D-measurement device energized; and
acquiring 3D coordinates of points on the feature with the 3D-measurement device as the spindle is moved over the feature.

11. The method of claim 10 further comprising wirelessly transmitting a signal from the 3D-measurement device to a remote device in response to acquiring the 3D coordinates.

12. The method of claim 10 wherein the step of acquiring 3D coordinates includes transmitting a line of light from a projector onto the feature and imaging light reflected off of the feature onto a photosensitive array.

13. The method of claim 10 further comprising:
measuring a first temperature indicative of a first temperature of the work piece; and
compensating the 3D coordinates of points on the feature based at least in part on the first temperature.

14. The method of claim 10 further comprising:
measuring a second temperature indicative of a second temperature of a zone within the machining center; and
compensating the 3D coordinates of points on the feature based at least in part on the second temperature.

15. The method of claim 10 wherein the 3D measurement device includes at least one projector and at least one camera arranged in a fixed geometric relationship to each other, the 3D measurement device further including a first shutter disposed between the at least one projector and an external environment and a second shutter disposed between the at least one camera and the external environment.

16. The method of claim 15 further comprising moving the first shutter and the second shutter from a closed position to an open position when the 3D measurement device is energized.
